(19) United States
(12) Patent Application Publication
(10) Pub. No.: US 2026/0137118 A1
(43) Pub. Date: May 21, 2026

(54) AEROSOL-GENERATING ARTICLE COMPRISING HOLLOW TUBLULAR ELEMENT WITH CAPSULE

(71) Applicant: Philip Morris Products S.A., Neuchatel (CH)

(72) Inventor: Jerome UTHURRY, Neuchâtel (CH)

(73) Assignee: Philip Morris Products S.A., Neuchatel (CH)

(21) Appl. No.: 19/121,846

(22) PCT Filed: Oct. 26, 2023
(86) PCT No.: PCT/EP2023/079992

§ 371 Date: Apr. 17, 2025

(30) Foreign Application Priority Data
Oct. 27, 2022 (EP) 22204207

(51) Int. Cl. A24D 1/20; A24D 1/02; A24D 3/17; A24F 40/20; A24F 40/46; H05B 3/02

(52) U.S. Cl. CPC A24D 1/20; A24D 1/027; A24D 3/17; A24F 40/20; A24F 40/46; H05B 3/02

(57) ABSTRACT

An aerosol-generating article for generating an inhalable aerosol upon heating is provided, the aerosol-generating article including: a hollow tubular element; and a capsule mounted within the hollow tubular element at an upstream end of the hollow tubular element, the capsule including: a capsule outer wall defining an internal cavity having a volume of at least 250 cubic millimetres, and a solid aerosol-generating substrate within the internal cavity of the capsule, the solid aerosol-generating substrate including nicotine and an aerosol former, the aerosol former content of the aerosol-generating substrate being at least 15 percent by weight, on a dry weight basis, and the density of the solid aerosol-generating substrate within the capsule being at least 0.1 milligrams per cubic millimetre of the internal cavity, the hollow tubular element defining an empty cavity downstream of the capsule.

The present invention relates to an aerosol-generating article comprising an aerosol-generating substrate and adapted to produce an inhalable aerosol upon heating.

Aerosol-generating articles in which an aerosol-generating substrate, such as a tobacco-containing substrate, is heated rather than combusted, are known in the art. Typically, in such heated smoking articles an aerosol is generated by the transfer of heat from a heat source to a physically separate aerosol-generating substrate or material, which may be located in contact with, within, around, or downstream of the heat source. During use of the aerosol-generating article, volatile compounds are released from the aerosol-generating substrate by heat transfer from the heat source and are entrained in air drawn through the aerosol-generating article. As the released compounds cool, they condense to form an aerosol.

A number of prior art documents disclose aerosol-generating devices for consuming aerosol-generating articles. Such devices include, for example, electrically heated aerosol-generating devices in which an aerosol is generated by the transfer of heat from one or more electrical heater elements of the aerosol-generating device to the aerosol-generating substrate of a heated aerosol-generating article. For example, electrically heated aerosol-generating devices have been proposed that comprise an internal heater blade which is adapted to be inserted into the aerosol-generating substrate.

Use of an aerosol-generating article in combination with an external heating system is also known. For example, WO 2020/115151 describes the provision of one or more heating elements arranged around the periphery of the aerosol-generating article when the aerosol-generating article is received in a cavity of the aerosol-generating device. As an alternative, inductively heatable aerosol-generating articles comprising an aerosol-generating substrate and a susceptor arranged within the aerosol-generating substrate have been proposed by WO 2015/176898.

Certain types of aerosol-generating substrates containing nicotine and a relatively high aerosol former content are known, for example, nicotine containing gels and films. Such substrates are typically very stable during storage and advantageously provide a very consistent delivery of nicotine to the consumer upon heating. They can also advantageously generate aerosol at a lower temperature than other solid substrates. However, the use of aerosol-generating substrates of this type can also present issues. The relatively high aerosol former content increases the risk of leakage of aerosol former from the substrate during storage as well as during use. In addition, certain substrates such as gel compositions will commonly melt upon heating of the aerosol-generating substrate within an aerosol-generating device during use. The viscosity of the gel composition therefore increases significantly and it can become more difficult to control the movement of the gel composition and in particular, to retain it within the aerosol-generating article. The leakage of aerosol former or melted gel composition from the aerosol-generating article is undesirable, since it can leak into the heating chamber of the aerosol-generating device and potentially contaminate the aerosol-generating device. The leakage of aerosol former or gel composition may also be potentially unpleasant for the consumer.

It would therefore be desirable to provide a novel aerosol-generating article having an arrangement that provides improved retention of the aerosol-generating substrate within the aerosol-generating article during storage and use. It would be further desirable to provide such an aerosol-generating article that enables the aerosol-generating substrate to be efficiently heated so that aerosol can be generated from the aerosol-generating substrate in an efficient and consistent way.

The present disclosure relates to an aerosol-generating article for generating an inhalable aerosol upon heating. The aerosol-generating article may comprise a hollow tubular element. The aerosol-generating article may further comprise a capsule mounted within the hollow tubular element. The capsule may be mounted at an upstream end of the hollow tubular element. The capsule may comprise: a capsule outer wall defining an internal cavity. The internal cavity may have a volume of at least 250 cubic millimetres. The capsule may further comprise a solid aerosol-generating substrate within the internal cavity of the capsule, the solid aerosol-generating substrate comprising nicotine and an aerosol former The aerosol former content of the aerosol-generating substrate may be at least 15 percent by weight, on a dry weight basis. The density of the solid aerosol-generating substrate within the capsule may be at least 0.1 milligrams per cubic millimetre of the internal cavity.

According to the present invention there is provided: an aerosol-generating article for generating an inhalable aerosol upon heating, the aerosol-generating article comprising: a hollow tubular element; and a capsule mounted within the hollow tubular element at an upstream end of the hollow tubular element. The capsule comprises: a capsule outer wall defining an internal cavity having a volume of at least 250 cubic millimetres; and a solid aerosol-generating substrate within the internal cavity of the capsule. The solid aerosol-generating substrate comprises nicotine and an aerosol former, wherein the aerosol former content of the aerosol-generating substrate is at least 15 percent by weight, on a dry weight basis and wherein the density of the solid aerosol-generating substrate within the capsule is at least 0.1 mg per cubic millimetre of the internal cavity.

The term “aerosol-generating article” is used herein to denote an article comprising an aerosol-generating substrate which is heated to produce and deliver an inhalable aerosol to a consumer. As used herein, the term “aerosol-generating substrate” denotes a substrate capable of releasing volatile compounds upon heating to generate an aerosol.

As used herein, the term “aerosol-generating device” refers to a device comprising a heater element that interacts with the aerosol-generating substrate of the aerosol-generating article to generate an aerosol.

As used herein, the term “density” refers to the bulk density of the solid aerosol-generating substrate within the internal cavity. The density is calculated by dividing the total mass of the solid aerosol-generating substrate and dividing it by the total volume of the internal cavity. The density therefore corresponds to the weight of solid aerosol-generating substrate per unit volume of the internal cavity. This is different to the density of the solid aerosol-generating substrate itself.

As used herein, the term “longitudinal” refers to the direction corresponding to the main longitudinal axis of the aerosol-generating article, which extends between the upstream and downstream ends of the aerosol-generating article. As used herein, the terms “upstream” and “downstream” describe the relative positions of elements, or portions of elements, of the aerosol-generating article in relation to the direction in which the aerosol is transported through the aerosol-generating article during use.

During use, air is drawn through the aerosol-generating article in the longitudinal direction. The term “transverse” refers to the direction that is perpendicular to the longitudinal axis. Any reference to the “cross-section” of the aerosol-generating article or a component of the aerosol-generating article refers to the transverse cross-section unless stated otherwise.

The term “length” denotes the dimension of a component of the aerosol-generating article in the longitudinal direction. For example, it may be used to denote the dimension of the hollow tubular element or capsule in the longitudinal direction.

As used herein, the term “solid” refers to an aerosol-generating substrate that is not a liquid or a gas and which does not low such that it retains its shape and form at room temperature. In the context of the present invention, the term “solid” encompasses gel materials and compositions.

The present invention relates to aerosol-generating articles having a unique configuration, with a hollow tubular element and a capsule mounted within the hollow tubular element, wherein the capsule contains a solid aerosol-generating substrate. Additional components may or may not be provided downstream of the capsule within the hollow tubular element, as discussed in more detail below. The use of a capsule to hold the solid aerosol-generating substrate within the aerosol-generating article provides a highly effective way to retain the aerosol-generating substrate in place within the aerosol-generating article during storage and use. As described in more detail below, the capsule can be provided with airflow pathways such that heating of the aerosol-generating substrate and generation of aerosol from the aerosol-generating substrate within the capsule is highly effective. The resultant aerosol can be efficiently delivered along the hollow tubular element to the consumer.

The arrangement of the capsule within the hollow tubular element is relatively simple and the amount of material required to produce the aerosol-generating article can therefore advantageously be reduced compared to existing aerosol-generating articles having a more complex structure. In particular, where aerosol-generating substrates are used that can generate aerosols at a relatively low temperature, such as gel compositions, it is possible to produce an aerosol-generating article according to the invention within minimal filtration material downstream of the capsule.

The configuration of the present invention is particularly beneficial for aerosol-generating substrates having a relatively high aerosol former content, such as aerosol-generating films and gel compositions of the type described below. The containment of the aerosol-generating substrate within the capsule prevents leakage of aerosol former from the aerosol-generating substrate during storage or use. In addition, in the event that the aerosol-generating substrate melts upon heating, as would be the case for many gel compositions, the melted substrate can be effectively retained within the capsule. Leakage of the aerosol former or aerosol-generating substrate from the aerosol-generating article during use can therefore be substantially prevented, so that the risk of contamination of the aerosol-generating device is advantageously minimised.

As defined above, the aerosol-generating articles of the present invention comprise an aerosol-generating substrate in solid form, contained within the capsule. The solid aerosol-generating substrate comprises nicotine and an aerosol former but may take a variety of different forms.

According to the invention, the aerosol-generating substrate comprises at least 15 percent by weight of aerosol former on a dry weight basis. Preferably, the aerosol-generating substrate comprises at least 20 percent by weight of aerosol former, on a dry weight basis. More preferably, the aerosol-generating substrate comprises at least 25 percent by weight of aerosol former, on a dry weight basis. More preferably, the aerosol-generating substrate comprises at least 30 percent by weight of aerosol former, on a dry weight basis. More preferably, the aerosol-generating substrate comprises at least 35 percent by weight of aerosol former, on a dry weight basis. More preferably, the aerosol-generating substrate comprises at least 40 percent by weight of aerosol former, on a dry weight basis. More preferably, the aerosol-generating substrate comprises at least 45 percent by weight of aerosol former, on a dry weight basis. More preferably, the aerosol-generating substrate comprises at least 50 percent by weight of aerosol former, on a dry weight basis.

Preferably, the aerosol-generating substrate comprises no more than 80 percent by weight on a dry weight basis. More preferably, the second aerosol-generating substrate comprises no more than 75 percent by weight on a dry weight basis. More preferably, the second aerosol-generating substrate comprises no more than 70 percent by weight on a dry weight basis.

For example, the aerosol-generating substrate may gave an aerosol former content of between 15 percent by weight and 80 percent by weight, or between 20 percent by weight and 80 percent by weight, or between 25 percent by weight and 80 percent by weight, or between 30 percent by weight and 75 percent by weight, or between 35 percent by weight and 75 percent by weight, or between 40 percent by weight and 70 percent by weight, or between 45 percent by weight and 70 percent by weight, or between 50 percent by weight and 70 percent by weight, on a dry weight basis.

In certain preferred embodiments, the aerosol former content of the aerosol-generating substrate may be between 40 percent and 80 percent by weight, or between 45 percent and 75 percent by weight, or between 50 percent and 70 percent by weight, on a dry weight basis. In such embodiments, the aerosol former content of the aerosol-generating substrate is therefore relatively high.

Suitable aerosol formers for inclusion in the aerosol-generating substrate are known in the art and include, but are not limited to: polyhydric alcohols, such as triethylene glycol, propylene glycol, 1,3-butanediol and glycerol; esters of polyhydric alcohols, such as glycerol mono-, di- or triacetate; and aliphatic esters of mono-, di- or polycarboxylic acids, such as dimethyl dodecanedioate and dimethyl tetradecanedioate.

Preferably, the aerosol-generating substrate comprises glycerol as aerosol former. For example, the aerosol-generating substrate may have a glycerol content of between 15 percent and 80 percent by weight, or between or between 20 percent by weight and 80 percent by weight, or between 25 percent by weight and 80 percent by weight, or between 30 percent by weight and 75 percent by weight, or between 35 percent by weight and 75 percent by weight, or between 40 percent by weight and 70 percent by weight, or between 45 percent by weight and 70 percent by weight, or between 50 percent by weight and 70 percent by weight, on a dry weight basis.

The aerosol-generating substrate further comprises nicotine. As used herein with reference to the invention, the term “nicotine” is used to describe nicotine, a nicotine base or a nicotine salt. In embodiments in which the aerosol-generating substrate comprises a nicotine base or a nicotine salt, the amounts of nicotine recited herein are the amount of free base nicotine or amount of protonated nicotine, respectively.

The aerosol-generating substrate may comprise natural nicotine or synthetic nicotine.

The nicotine may comprise one or more nicotine salts. The one or more nicotine salts may be selected from the list consisting of nicotine lactate, nicotine citrate, nicotine pyruvate, nicotine bitartrate, nicotine benzoate, nicotine pectate, nicotine alginate, and nicotine salicylate.

The nicotine may comprise an extract of tobacco.

Preferably, the aerosol-generating substrate comprises at least 0.5 percent by weight of nicotine on a dry weight basis. More preferably, the aerosol-generating substrate comprises at least 1 percent by weight of nicotine on a dry weight basis. Even more preferably, the aerosol-generating substrate comprises at least 2 percent by weight of nicotine on a dry weight basis. In addition, or as an alternative, the aerosol-generating substrate preferably comprises less than 10 percent by weight of nicotine on a dry weight basis. More preferably, the aerosol-generating substrate comprises less than 8 percent by weight of nicotine on a dry weight basis. More preferably, the aerosol-generating substrate comprises less than 6 percent by weight of nicotine on a dry weight basis.

For example, the aerosol-generating substrate may comprise between 0.5 percent and 10 percent by weight of nicotine, or between 1 percent and 8 percent by weight of nicotine, or between 2 percent and 6 percent by weight of nicotine, on a dry weight basis.

The aerosol-forming substrate may comprise one or more carboxylic acids. Advantageously, including one or more carboxylic acids in the aerosol-forming substrate may create a nicotine salt.

The one or more carboxylic acids comprise one or more of lactic acid and levulinic acid. Advantageously, the present inventors have found that lactic acid and levulinic acid are particularly good carboxylic acids for creating nicotine salts.

Preferably, the aerosol-forming substrate comprises at least 0.5 percent by weight of carboxylic acid, on a dry weight basis. More preferably, the aerosol-forming substrate comprises at least 1 percent by weight of carboxylic acid, on a dry weight basis. More preferably, the aerosol-forming substrate comprises at least 2 percent by weight of carboxylic acid, on a dry weight basis.

In addition, or as an alternative, the aerosol-generating substrate preferably comprises less than 15 percent by weight of carboxylic acid, on a dry weight basis. More preferably, the aerosol-generating substrate preferably comprises less than 10 percent by weight of carboxylic acid, on a dry weight basis. More preferably, the aerosol-generating substrate preferably comprises less than 5 percent by weight of carboxylic acid, on a dry weight basis. For example, the aerosol-generating substrate may comprise between 0.5 percent and 15 percent by weight of carboxylic acid, or between 1 percent and 10 percent by weight of carboxylic acid, or between 2 percent and 5 percent by weight of carboxylic acid.

In certain preferred embodiments, the aerosol-generating substrate is in the form of an aerosol-generating film comprising a cellulosic based film forming agent, nicotine and aerosol former. The aerosol-generating film may further comprise a cellulose based strengthening agent. The aerosol-generating film may further comprise water, preferably 30 percent by weight of less of water.

As used herein, the term “film” is used to describe a solid laminar element having a thickness that is less than the width or length thereof. The film may be self-supporting. In other words, a film may have cohesion and mechanical properties such that the film, even if obtained by casting a film-forming formulation on a support surface, can be separated from the support surface. Alternatively, the film may be disposed on a support or sandwiched between other materials. This may enhance the mechanical stability of the film.

The aerosol former content of the aerosol-generating film is within the ranges defined above for the aerosol-generating substrate.

In the context of the present invention the term “cellulose based film-forming agent” is used to describe a cellulosic polymer capable, by itself or in the presence of an auxiliary thickening agent, of forming a continuous film.

Preferably, the cellulose based film-forming agent is selected from the group consisting of hydroxypropyl methylcellulose (HPMC), methylcellulose (MC), ethylcellulose (EC), hydroxyethyl methyl cellulose (HEMC), hydroxyethyl cellulose (HEC), hydroxypropyl cellulose (HPC), and combinations thereof.

More preferably, the cellulose based film-forming agent is selected from the group consisting of hydroxypropyl methylcellulose (HPMC), methylcellulose (MC), ethylcellulose (EC), and combinations thereof.

In particularly preferred embodiments, the cellulose based film-forming agent is HPMC.

The aerosol-generating film may have a cellulose based film-forming agent content of between 10 percent and 40 percent by weight, or between 15 percent and 35 percent by weight, or between 20 percent and 30 percent by weight, on a dry weight basis.

Preferably, the aerosol-generating film further comprises a cellulose based strengthening agent. Preferably, the cellulose based strengthening agent is selected from the group consisting of cellulose fibres, microcrystalline cellulose (MCC), cellulose powder, and combinations thereof.

The aerosol-generating film may have a cellulose based strengthening agent content of between 0.5 percent and 40 percent by weight on a dry weight basis, or between 5 percent and 30 percent by weight on a dry weight basis, or between 10 percent and 25 percent by weight on a dry weight basis.

The aerosol-generating film may further comprise a carboxymethyl cellulose, preferably sodium carboxymethyl cellulose.

The aerosol-generating film may have a carboxymethyl cellulose content of between 1 percent and 15 percent by weight, or between 2 percent and 12 percent by weight, or between 4 percent and 10 percent by weight on a dry weight basis.

The nicotine content of the aerosol-generating film is within the ranges defined above for the aerosol-generating substrate.

The aerosol-generating film may be a substantially tobacco-free aerosol-generating film.

In preferred embodiments, the aerosol-generating film comprises an acid. More preferably, the aerosol-generating film comprises one or more organic acids. Even more preferably, the aerosol-generating film comprises one or more carboxylic acids. In particularly preferred embodiments, the acid is lactic acid, benzoic acid, fumaric acid or levulinic acid.

Preferably, the aerosol-generating film comprises between 0.25 percent and 3.5 percent by weight of an acid, or between 0.5 percent and 3 percent by weight of an acid, or between 1 percent and 2.5 percent by weight of an acid, on a dry weight basis.

The aerosol-generating film may have a thickness from about 0.1 millimetres to about 1 millimetre, more preferably from about 0.1 millimetres to about 0.75 millimetres, even more preferably from about 0.1 millimetres to about 0.5 millimetres. In particularly preferred embodiments, a layer of the film-forming composition is formed that has a thickness from about 50 micrometres to 400 micrometres, more preferably from about 100 micrometres to 200 micrometres.

The aerosol-generating film may optionally be provided on a suitable carrier element.

In alternative preferred embodiments of the present invention, the aerosol-generating substrate comprises a gel composition that comprises nicotine, at least one gelling agent and aerosol former. The gel composition is preferably substantially tobacco free.

The preferred weight ranges for nicotine in the gel composition are the same as those defined above in relation to aerosol-generating films.

The gel composition preferably comprises at least 50 percent by weight of aerosol former, more preferably at least 60 percent by weight, more preferably at least 70 percent by weight of aerosol former, on a dry weight basis. The gel composition may comprise up to 80 percent by weight of aerosol former. The aerosol former in the gel composition is preferably glycerol.

The gel composition preferably includes at least one gelling agent. Preferably, the gel composition includes a total amount of gelling agents in a range from about 0.4 percent by weight to about 10 percent by weight, or from about 0.5 percent by weight to about 8 percent by weight, or from about 1 percent by weight to about 6 percent by weight, or from about 2 percent by weight to about 4 percent by weight, or from about 2 percent by weight to about 3 percent by weight.

The term “gelling agent” refers to a compound that homogeneously, when added to a 50 percent by weight water/50 percent by weight glycerol mixture, in an amount of about 0.3 percent by weight, forms a solid medium or support matrix leading to a gel. Gelling agents include, but are not limited to, hydrogen-bond crosslinking gelling agents, and ionic crosslinking gelling agents.

The term “hydrogen-bond crosslinking gelling agent” refers to a gelling agent that forms non-covalent crosslinking bonds or physical crosslinking bonds via hydrogen bonding.

The hydrogen-bond crosslinking gelling agent may include one or more of a galactomannan, gelatin, agarose, or konjac gum, or agar. The hydrogen-bond crosslinking gelling agent may preferably include agar.

The term “ionic crosslinking gelling agent” refers to a gelling agent that forms non-covalent crosslinking bonds or physical crosslinking bonds via ionic bonding.

The ionic crosslinking gelling agent may include low acyl gellan, pectin, kappa carrageenan, iota carrageenan or alginate. The ionic crosslinking gelling agent may preferably include low acyl gellan.

The gelling agent may include one or more biopolymers. The biopolymers may be formed of polysaccharides.

Biopolymers include, for example, gellan gums (native, low acyl gellan gum, high acyl gellan gums with low acyl gellan gum being preferred), xanthan gum, alginates (alginic acid), agar, guar gum, and the like. The composition may preferably include xanthan gum. The composition may include two biopolymers. The composition may include three biopolymers. The composition may include the two biopolymers in substantially equal weights. The composition may include the three biopolymers in substantially equal weights.

The gel composition may further include a viscosifying agent. The viscosifying agent combined with the hydrogen-bond crosslinking gelling agent and the ionic crosslinking gelling agent appears to surprisingly support the solid medium and maintain the gel composition even when the gel composition comprises a high level of glycerol.

The term “viscosifying agent” refers to a compound that, when added homogeneously into a 25° C., 50 percent by weight water/50 percent by weight glycerol mixture, in an amount of 0.3 percent by weight, increases the viscosity without leading to the formation of a gel, the mixture staying or remaining fluid.

The gel composition preferably includes the viscosifying agent in a range from about 0.2 percent by weight to about 5 percent by weight, or from about 0.5 percent by weight to about 3 percent by weight, or from about 0.5 percent by weight to about 2 percent by weight, or from about 1 percent by weight to about 2 percent by weight.

The viscosifying agent may include one or more of xanthan gum, carboxymethyl-cellulose, microcrystalline cellulose, methyl cellulose, gum Arabic, guar gum, lambda carrageenan, or starch. The viscosifying agent may preferably include xanthan gum.

The gel composition may further include a divalent cation. Preferably the divalent cation includes calcium ions, such as calcium lactate in solution. Divalent cations (such as calcium ions) may assist in the gel formation of compositions that include gelling agents such as the ionic crosslinking gelling agent, for example. The ion effect may assist in the gel formation. The divalent cation may be present in the gel composition in a range from about 0.1 to about 1 percent by weight, or about 0.5 percent by weight.

The gel composition may further include an acid. The acid may comprise a carboxylic acid. The carboxylic acid may include a ketone group. Preferably the carboxylic acid may include a ketone group having less than about 10 carbon atoms, or less than about 6 carbon atoms or less than about 4 carbon atoms, such as levulinic acid or lactic acid. Preferably this carboxylic acid has three carbon atoms (such as lactic acid).

The gel composition preferably comprises some water. The gel composition is more stable when the composition comprises some water.

Preferably the gel composition comprises between about 8 percent by weight to about 32 percent by weight water, or from about 15 percent by weight to about 25 percent by weight water, or from about 18 percent by weight to about 22 percent by weight water, or about 20 percent by weight water.

The solid aerosol-generating substrate may be provided in any suitable form. Preferably, the capsule contains a plurality of particles of the solid aerosol-generating substrate. For example, the capsule may comprise a plurality of beads, pellets, granules, strips, shreds or flakes of the aerosol-generating substrate.

In certain embodiments, the maximum dimension of each of the particles is preferably at least 0.05 millimetres, more preferably at least 0.1 millimetres, more preferably at least 0.15 millimetres, more preferably at least 0.2 millimetres, more preferably at least 0.25 millimetres, more preferably at least 0.5 millimetres, more preferably at least 0.75 millimetres, more preferably at least 1 millimetre. Preferably, the maximum dimension of each of the particles is no more than 10 millimetres, more preferably no more than 9 millimetres, more preferably no more than 8 millimetres, more preferably no more than 6 millimetres, more preferably no more than 5 millimetres. Providing relatively large particles within these ranges may be preferable when the capsule wall is provided with holes to form air inlets and outlets, as described below. The relatively large maximum dimension of the particles will then ensure that the particles are not lost through the holes in the capsule wall.

The maximum dimension of a particle corresponds to the largest external diameter of that particles. Where the particles are substantially spherical, the maximum dimension of a particle will correspond to the diameter of that particle.

In such embodiments, the capsule preferably comprises at least 2 particles of the aerosol-generating substrate, more preferably at least 5 particles of the aerosol-generating substrate, more preferably at least 10 particles of the aerosol-generating substrate, more preferably at least 20 particles of the aerosol-generating substrate, more preferably at least 30 particles. The capsule may contain up to 200 particles.

In other embodiments, the solid aerosol-generating substrate may be in the form of a powder having a larger number of much smaller particles. For example, in such embodiments, the powder may be formed of particles having a D50 size of between 50 micrometres and 80 micrometres, between 50 micrometres and 75 micrometres, between 55 micrometres and 75 micrometres, between 55 micrometres and 70 micrometres, or between 60 micrometres and 70 micrometres.

As used herein with reference to the present invention, the term “D50 size” refers to the median particle size of the particulate material or powder. The D50 size is the particle size which splits the distribution in half, where half of the particles are larger than the D50 size and half of the particles are smaller than the D50 size. The particle size distribution may be determined by laser diffraction. For example, the particle size distribution may be determined by laser diffraction using a Malvern Mastersizer 3000 laser diffraction particle size analyser in accordance with the manufacturer's instructions.

The powder may be formed of particles having a D95 size of between 80 micrometres and 130 micrometres, between 90 micrometres and 125 micrometres, between 100 micrometres and 120 micrometres, or between 110 micrometres and 120 micrometres.

As used herein with reference to the present invention, the term “D95 size” is the size at which the proportion by mass of particles with sizes below this value is 95 percent.

The powder may be formed of particles having a maximum diameter of between 50 micrometres and 250 micrometres, between 80 micrometres and 225 micrometres, or between 100 micrometres and 125 micrometres.

In embodiments where the capsule contains a plurality of particles, the mass of each particle is preferably at least 0.05 micrograms, more preferably at least 0.1 micrograms, more preferably at least 0.2 micrograms, more preferably at least 0.3 micrograms, more preferably at least 0.4 micrograms, more preferably at least 0.5 micrograms, more preferably at least 0.6 micrograms, more preferably at least 0.7 micrograms, more preferably at least 0.8 micrograms, more preferably at least 0.9 micrograms, more preferably at least 1 microgram, more preferably at least 10 micrograms, more preferably at least 100 micrograms, more preferably at least 200 micrograms, more preferably at least 500 micrograms, more preferably at least 1 milligram. The mass of each particle is preferably no more than 600 milligrams, more preferably no more than 500 milligrams, more preferably no more than 400 milligrams, more preferably no more than 300 milligrams, more preferably no more than 200 milligrams, more preferably no more than 100 milligrams, more preferably no more than 50 milligrams, more preferably no more than 10 milligrams.

Alternatively, the solid aerosol-generating substrate may be in the form of one or more sheets. As used herein with reference to the invention, the term “sheet” describes a laminar element having a width and length substantially greater than the thickness thereof.

The one or more sheets as described herein may have been one or more of crimped, folded, gathered and pleated. The one or more sheets may be cut into strands.

As defined above, in the aerosol-generating article of the present invention, the solid aerosol-generating substrate is contained within a capsule. The capsule comprises a capsule outer wall which defines the internal cavity that contains the solid aerosol-generating substrate.

The capsule outer wall may be formed of any suitable material. Preferably, the capsule outer wall is formed of an air impermeable material, most preferably an air impermeable polymeric material. This ensures that air does not pass through the capsule outer wall, other than in the holes provided specifically for airflow during use. The airflow through the capsule during use can therefore be effectively controlled.

The capsule outer wall may comprise a polymeric material or a cellulose based material. For example, the capsule outer wall may be made of one or more polymers that are compatible with nicotine, including medical grade polymers such as ALTUGLAS® Medical Resins Polymethlymethacrylate (PMMA), Chevron Phillips K-Resin® Styrene-butadiene copolymer (SBC), Arkema special performance polymers Pebax®, Rilsan®, and Rilsan® Clear, DOW (Health+™) Low-Density Polyethylene (LDPE), DOW™ LDPE 91003, DOW™ LDPE 91020 (MFI 2.0; density 923), ExxonMobil™ Polypropylene (PP) pp 1013H1, pp 1014H1 and pp 9074MED, Trinseo CALIBRE™ Polycarbonate (PC) 2060-SERIES.

The capsule outer wall may alternatively be formed from one or more materials selected from: polyethylene (PE), polypropylene (PP), polyvinylchloride (PVC), polyethylene terephthalate (PET), polylactic acid (PLA), cellulose acetate (CA), gelatin and hydroxypropyl methyl cellulose (HPMC).

In embodiments in which it is intended for the capsule outer wall to be pierced by a heating element or piercing element in the aerosol-generating device, as described below, the capsule outer wall should be formed of a pierceable or frangible material. The upstream end wall of the capsule may optionally comprise one or more lines or areas of weakness, which are positioned in order to facilitate the insertion of a heating element through the capsule outer wall during use.

The capsule is preferably capsule shaped, in the form of a sphero-cylinder, with a cylindrical portion defined by a cylindrical wall and rounded, hemispherical end walls at each end of the cylindrical portion. This type of capsule is commonly used in the pharmaceutical industry. Alternatively, the capsule may be spherical, or ovoid.

Preferably, the capsule is a two part capsule, with two separate parts that fit together to close the capsule and retain the contents. The two separate parts may fit together by means of a friction fit, without adhesive. Alternatively, an adhesive may be used to seal the two parts together.

Preferably, the capsule comprises a first part and a second part, wherein the second part has a smaller outer diameter than the first part such that an end of the second part can be inserted into an open end of the first part in order to close the capsule. Preferably, when the capsule is mounted within the hollow tubular element, the second part of the capsule is provided downstream of the first part.

In such embodiments, the outer diameters of the first part and the second part of the capsule may be adapted such that only the second part of the capsule can be received within the hollow tubular element. The outer diameter of the first part of the capsule is adapted to be larger than the internal diameter of the hollow tubular element so that the first part of the capsule cannot be received within the hollow tubular element and remains outside of the hollow tubular element at the upstream end. Preferably, the second part of the capsule is retained within the hollow tubular element by means of a friction fit. The first part prevents the capsule from being pushed any further into the hollow tubular element.

Alternatively in such embodiments, the capsule may be fully inserted into the hollow tubular element and the outer diameters of the first part and the second part of the capsule may be adapted such that the outer diameter of the second part is smaller than the internal diameter of the hollow tubular element. This provides a space between the second part of the capsule and the wall of the hollow tubular element to enable airflow around the second part of the capsule. Such an arrangement may be beneficial in embodiments in which it is desired to position air outlets on the cylindrical wall of the capsule, as described below. The outer diameter of the first part of the capsule is preferably adapted such that the first part of the capsule is retained within the hollow tubular article by means of a friction fit. Alternatively, the first part of the capsule may be retained in place by means of a suitable adhesive. Either of these arrangements preferably substantially prevents airflow around the first part of the capsule, downstream from the second part of the capsule.

The internal cavity of the capsule has a volume of at least 250 cubic millimetres, corresponding to 0.25 millimetres. This corresponds to the internal volume of the capsule, or the capacity. Preferably, the internal cavity of the capsule has a volume of at least 400 cubic millimetres (0.4 millilitres), more preferably at least 500 cubic millimetres (0.5 millilitres), more preferably at least 600 cubic millimetres (0.6 millilitres). The internal cavity of the capsule may be less than 2000 cubic millimetres (2 millilitres), or less than 1500 cubic millimetres (1.5 millilitres) or less than 1000 cubic millimetres (1 millilitre). For example, standard capsule sizes 000, 00, 0, 0, 1, 2 and 3 may be suitable.

The capsule preferably has a length of at least 10 millimetres, more preferably at least 12 millimetres, more preferably at least 15 millimetres, more preferably at least 18 millimetres. The length of the capsule is preferably less than 30 millimetres, more preferably less than 28 millimetres, more preferably less than 25 millimetres. For example, the capsule length may be between 10 millimetres and 30 millimetres, or between 12 millimetres and 28 millimetres, or between 15 millimetres and 25 millimetres, or between 18 millimetres and 25 millimetres. The capsule length may be around 20 millimetres.

The capsule preferably has a maximum diameter of at least 5 millimetres, more preferably at least 5.5 millimetres, more preferably at least 6 millimetres, more preferably at least 6.5 millimetres. The maximum diameter of the capsule is preferably less than 9 millimetres, more preferably less than 8.5 millimetres, more preferably less than 8 millimetres, more preferably less than 7.5 millimetres. For example, the capsule maximum diameter may be between 5 millimetres and 9 millimetres, or between 5.5 millimetres and 8.5 millimetres, or between 6 millimetres and 6 millimetres, or between 6.5 millimetres and 7.5 millimetres. The capsule maximum diameter may be around 7 millimetres.

The internal cavity of the capsule preferably contains at least 50 milligrams of the solid aerosol-generating substrate, more preferably at least 100 milligrams of the solid aerosol-generating substrate, more preferably at least 150 milligrams of the solid aerosol-generating substrate. The internal cavity may contain up to 1000 milligrams of the solid aerosol-generating substrate, or up to 750 milligrams of the solid aerosol-generating substrate, or up to 500 milligrams of the solid aerosol-generating substrate, or up to 250 milligrams of the solid aerosol-generating substrate. For example, the internal cavity of the capsule may contain between 50 milligrams and 1000 milligrams of the solid aerosol-generating substrate, or between 100 milligrams and 750 milligrams of the solid aerosol-generating substrate, or between 150 milligrams and 500 milligrams of the solid aerosol-generating substrate, or between 150 milligrams and 250 milligrams of the solid aerosol-generating substrate.

According to the invention, the density of the solid aerosol-generating substrate within the capsule is at least 0.1 milligrams per cubic millimetre of the internal cavity. As defined above, this corresponds to the total weight of the solid aerosol-generating substrate within the capsule, divided by the total volume of the internal cavity. Preferably, the density of the solid aerosol-generating substrate within the capsule is at least 0.12 milligrams per cubic millimetre of the internal cavity, more preferably at least 0.15 milligrams per cubic millimetre of the internal cavity, more preferably at least 0.18 milligrams per cubic millimetre of the internal cavity, more preferably at least 0.2 milligrams per cubic millimetre, more preferably at least 0.22 milligrams per cubic millimetre, more preferably at least 0.25 milligrams per cubic millimetre, more preferably at least 0.28 milligrams per cubic millimetre, more preferably at least 0.3 milligrams per cubic millimetre, more preferably at least 0.32 milligrams per cubic millimetre, more preferably at least 0.35 milligrams per cubic millimetre, more preferably at least 0.38 milligrams per cubic millimetre, more preferably at least 0.4 milligrams per cubic millimetre.

Preferably, the density of the solid aerosol-generating substrate within the capsule is less than 2 milligrams per cubic millimetre of the internal cavity, more preferably less than 1.9 milligrams per cubic millimetre, more preferably less than 1.8 milligrams per cubic millimetre, more preferably less than 1.7 milligrams per cubic millimetre, more preferably less than 1.6 milligrams per cubic millimetre, more preferably less than 1.5 milligrams per cubic millimetre, more preferably less than 1.4 milligrams per cubic millimetre, more preferably less than 1.3 milligrams per cubic millimetre, more preferably less than 1.2 milligrams per cubic millimetre, more preferably less than 1.1 milligrams per cubic millimetre, more preferably less than 1 milligram per cubic millimetre of the internal cavity.

For example, the density of the solid aerosol-generating substrate within the capsule may correspond to between 0.1 milligrams per cubic millimetre and 2 milligrams per cubic millimetre of the internal cavity, or between 0.12 milligrams per cubic millimetre and 1.9 milligrams per cubic millimetre of the internal cavity, or between 0.15 milligrams per cubic millimetre and 1.8 milligrams per cubic millimetre of the internal cavity, or between 0.18 milligrams per cubic millimetre and 1.7 milligrams per cubic millimetre of the internal cavity, or between 0.2 milligrams per cubic millimetre and 1.6 milligrams per cubic millimetre of the internal cavity, or between 0.22 milligrams per cubic millimetre and 1.5 milligrams per cubic millimetre of the internal cavity, or between 0.25 milligrams per cubic millimetre and 1.4 milligrams per cubic millimetre of the internal cavity, or between 0.28 milligrams per cubic millimetre and 1.3 milligrams per cubic millimetre of the internal cavity, or between 0.3 milligrams per cubic millimetre and 1.2 milligrams per cubic millimetre of the internal cavity, or between 0.32 milligrams per cubic millimetre and 1.1 milligrams per cubic millimetre of the internal cavity, or between 0.35 milligrams per cubic millimetre and 1 milligrams per cubic millimetre of the internal cavity, or between 0.38 milligrams per cubic millimetre and 1 milligrams per cubic millimetre of the internal cavity, or between 0.4 milligrams per cubic millimetre and 1 milligrams per cubic millimetre of the internal cavity

The percentage fill of the capsule by the solid aerosol-generating substrate is preferably at least 50 percent, more preferably at least 60 percent, more preferably at least 70 percent. The percentage fill is preferably less than 90 percent. The percentage fill corresponds to the percentage of the internal cavity of the capsule that is occupied by the solid aerosol-generating substrate. It may be advantageous to retain some empty space within the internal cavity to allow for air flow through the internal cavity and for the solid aerosol-generating substrate to be heated evenly.

The capsule should be adapted such that one or more airflow pathways is provided through the capsule during heating. This enables the aerosol generated from the aerosol-generating substrate to be drawn through the aerosol-generating article and delivered to the consumer. The capsule may be initially sealed and airtight but adapted such that airflow pathways are created when the aerosol-generating article is inserted into an aerosol-generating device, for example, through the insertion of an internal heating element or by means of a piercing element which pierces the capsule outer wall.

Alternatively and preferably, the capsule comprises at least one air inlet and at least one air outlet in the capsule outer wall. The at least one air inlet and the at least one air outlet define one or more airflow pathways through the internal cavity of the capsule. The at least one air outlet is provided downstream of the at least one air inlet.

Preferably, the capsule comprises a plurality of air inlets. For example, the capsule may comprise between 2 and 6 air inlets.

Preferably, the capsule comprises a plurality of air outlets. For example, the capsule may comprise between 2 and 6 air outlets. The number of air outlets may be the same as the number of air inlets, or different. It may be advantageous to provide a greater number of air outlets than air inlets, since the air outlets need to allow the aerosol generated within the capsule to pass out of the capsule into the hollow tubular element.

The number and size of the air inlets and air outlets may be adjusted in order to control the airflow through the capsule and also the resistance to draw (RTD) of the aerosol-generating article. In certain embodiments, the capsule will provide the main source of RTD within the article and the overall RTD of the aerosol-generating article is therefore likely to be very dependent on the RTD of the capsule.

Each air inlet and air outlet is preferably in the form of a hole through the capsule outer wall. Preferably, each hole is spherical, although other shapes may also be suitable. The diameter of each hole should be sufficiently large that the hole cannot easily be blocked, for example, by dust. However, the diameter of each hole should also be adapted depending on the form and nature of the solid aerosol-generating substrate, so that the solid aerosol-generating substrate is not lost from the internal cavity, through the hole.

Preferably, each hole forming an air inlet or air outlet has a diameter of at least 0.2 millimetres, more preferably at least 0.25 millimetres, more preferably at least 0.3 millimetres, more preferably at least 0.35 millimetres, more preferably at least 0.4 millimetres, more preferably at least 0.5 millimetres. The diameter of each hole may be less than 2 millimetres, or less than 1.8 millimetres, or less than 1.6 millimetres, or less than 1.4 millimetres, or less than 1.2 millimetres, or less than 1 millimetre, or less than 0.9 millimetres, or less than 0.8 millimetres. For example, the diameter of each hole may be between 0.2 millimetres and 2 millimetres, or between 0.25 millimetres and 1.8 millimetres, or between 0.3 millimetres and 1.6 millimetres, or between 0.35 millimetres and 1.4 millimetres, or between 0.4 millimetres and 1.2 millimetres, or between 0.45 millimetres and 1 millimetres, or between 0.5 millimetres and 0.9 millimetres or between 0.5 millimetres and 0.8 millimetres.

Where a plurality of air inlets or air outlets is provided, the respective holes should be spaced apart sufficiently so that the presence of the holes does not adversely impact the structural integrity of the capsule. For example, the holes are preferably spaced at least 1 millimetre apart from each other.

The at least one air outlet is preferably at least 5 millimetres downstream of the at least one air inlet, more preferably at least 8 millimetres downstream of the at least one air inlet and more preferably at least 10 millimetres downstream of the at least one air inlet. This spacing enables the length of the airflow pathway through the capsule to be maximised.

The at least one air outlet is preferably positioned at the downstream end of the capsule. Where the capsule has a conventional capsule shape, with an elongate cylindrical body and rounded end walls, the at least one air outlet is preferably provided on the downstream end wall.

The at least one air inlet may be positioned at the upstream end of the capsule. For example, where the capsule has a conventional capsule shape as described above, the at least one air inlet may be provided on the upstream end wall. However, in certain embodiments it may be advantageous to position the at least one air inlet a certain distance downstream of the upstream end. For example, the at least one air inlet may be provided at least 2 millimetres downstream of the upstream end of the capsule, or at least 3 millimetres downstream of the upstream end of the capsule, or at least 4 millimetres downstream of the upstream end of the capsule, or at least 5 millimetres downstream of the upstream end of the capsule. Where a plurality of air inlets are provided, all of the air inlets should be provided at least this distance from the upstream end, even when the position of the air inlets along the length of the capsule varies.

In preferred embodiments, the capsule comprises a cylindrical wall and rounded end walls at the upstream and downstream ends of the cylindrical wall (as in a conventional capsule shape) and the at least one air inlet may advantageously be provided in the cylindrical wall, downstream of the upstream end wall.

This positioning of the at least one air inlet away from the upstream end of the capsule may be particularly beneficial when the solid aerosol-generating substrate is in the form of a gel composition, as described above, or any other type of substrate that melts or becomes more viscous upon heating. By the at least one air inlet away from the upstream end of the cavity, where the melted substrate may collect, this ensures that the risk of the aerosol-generating substrate leaking from the capsule is minimised. The risk of blockage of the air inlets by the aerosol-generating substrate is also reduced.

The capsule needs to be mounted within the hollow tubular element such that the at least one air inlet is not covered or blocked by the wall of the hollow tubular element, in particular, where the at least one air inlet is provided on the cylindrical wall of the capsule, as described above. There are various suitable ways to achieve this, as described below.

In certain embodiments, the hollow tubular element comprises one or more holes extending through the peripheral wall thereof, which are positioned to coincide with the one or more air inlets on the capsule. With such an arrangement, air can pass from outside of the hollow tubular element, through the peripheral wall thereof and into the at least one air inlet.

In alternative embodiments, the capsule is mounted within the hollow tubular element such that a portion of the capsule extends from the upstream end of the hollow tubular element, whereby the at least one air inlet is positioned outside of the hollow tubular element. Preferably, at least 20 percent of the length of the capsule protrudes from the hollow tubular element, more preferably at least 30 percent of the length of the capsule. Preferably, no more than 50 percent of the length of the capsule protrudes from the hollow tubular element. The majority of the capsule is therefore within the hollow tubular element such that the capsule can be securely retained in place. In such embodiments, the hollow tubular element may comprise a flange or protrusion extending inwards from the internal surface at the downstream end of the capsule, to prevent the capsule from being pushed downstream further into the hollow tubular element. For example, the hollow tubular element may comprise an annular flange extending from the internal surface.

In further alternative embodiments, the capsule is provided with an outer diameter that is less than the internal diameter of the hollow tubular element. This arrangement provides a space between the outer surface of the capsule and the inner surface of the hollow tubular element, such that air can pass between the capsule and the hollow tubular element, to the at least one air inlet. In such embodiments, it is necessary to block the flow of air from the upstream end of the hollow tubular element to the at least one air outlet in the capsule wall. In this way, the main airflow pathway is clearly defined through the capsule and not around the outside. This can be achieved, for example, by providing an annular sealing ring around the capsule, within the hollow tubular element, which seals the space between the capsule and the inner surface of the hollow tubular element at a position downstream of the at least one air inlet. The annular sealing ring advantageously also helps to retain the position of the capsule within the hollow tubular element.

In such embodiments, the outer diameter of the capsule is preferably at least 0.2 millimetres less than the internal diameter of the hollow tubular element, more preferably at least 0.5 millimetres less than the internal diameter of the hollow tubular element, more preferably at least 0.8 millimetres less than the internal diameter of the hollow tubular element. The outer diameter of the capsule may be up to 2 millimetres less than the internal diameter of the hollow tubular element.

In further alternative embodiments, the inner surface of the hollow tubular element is corrugated at the upstream end thereof, to define a plurality of longitudinal channels which are circumferentially arranged to substantially coincide with the at least one air inlet. With such an arrangement, air can enter the hollow tubular element through the longitudinal channels defined by the corrugated surface and pass along the capsule to the at least one air inlet. The hollow tubular element is preferably corrugated along only a part of its length from the upstream end and not along the full length. The longitudinal channels therefore preferably extend to a position upstream of the at least one air outlet so that there is no flow of air from the upstream end of the hollow tubular element to the at least one air outlet. In this way, the main airflow pathway is clearly defined through the capsule and not around the outside.

As described above, in the aerosol-generating articles of the present invention, the capsule containing the solid aerosol-generating substrate is mounted within a hollow tubular element. The hollow tubular element provides the main structural element of the aerosol-generating article. Preferably, the hollow tubular element extends to the downstream end of the aerosol-generating article.

As used herein, the term “hollow tubular element” denotes a generally elongate element defining a lumen or channel along a longitudinal axis thereof. In particular, the term “tubular” will be used in the following with reference to a tubular element having a substantially cylindrical cross-section and defining at least channel extending between an upstream end of the tubular element and a downstream end of the tubular element. However, it will be understood that alternative geometries (for example, alternative cross-sectional shapes) of the tubular element may be possible.

The hollow tubular element has the capsule containing the aerosol-generating substrate mounted at the upstream end, as described above. Further, the hollow tubular element defines an empty cavity downstream of the capsule, which extends along a part or all of the length of the hollow tubular element. In some embodiments, the empty cavity extends from the capsule all of the way to the downstream end of the aerosol-generating article. In such embodiments, the aerosol-generating article can therefore be formed with only two elements: the capsule and the hollow tubular element. Alternatively, one or more filter segments may be provided within the hollow tubular element, at the downstream end thereof, as described in more detail below.

The empty cavity defined within the hollow tubular element downstream of the capsule preferably has a length of at least 10 millimetres, more preferably at least 12 millimetres and more preferably at least 14 millimetres. The length of the empty cavity may be up to 40 millimetres, or up to 30 millimetres, or up to 25 millimetres. For example, the empty cavity may have a length of between 10 millimetres and 40 millimetres, or between 12 millimetres and 30 millimetres, or between 14 millimetres and 25 millimetres.

The hollow tubular element preferably has a total length of at least 25 millimetres, more preferably at least 28 millimetres, more preferably at least 30 millimetres, more preferably at least 32 millimetres, more preferably at least 34 millimetres. The length of the hollow tubular element may be less than 50 millimetres, or less than 48 millimetres, or less than 45 millimetres, or less than 42 millimetres or less than 40 millimetres. For example, the total length of the hollow tubular element may be between 25 millimetres and 50 millimetres, or between 28 millimetres and 48 millimetres, or between 30 millimetres and 45 millimetres, or between 32 millimetres and 42 millimetres, or between 34 millimetres and 40 millimetres.

The hollow tubular element may have an outer diameter of between 5 millimetres and 12 millimetres, for example of between 5 millimetres and 10 millimetres or of between 6 millimetres and 8 millimetres. In a preferred embodiment, the hollow tubular element has an external diameter of 7.2 millimetres plus or minus 10 percent.

The internal diameter of the hollow tubular element is preferably constant along the length of the hollow tubular element. The lumen or cavity of the hollow tubular element may have any cross-sectional shape. The lumen of the hollow tubular element may have a circular cross-sectional shape.

Preferably, the internal diameter of the hollow tubular element is at least 5 millimetres, more preferably at least 5.5 millimetres, more preferably at least 6 millimetres, more preferably at least 6.5 millimetres. The internal diameter of the hollow tubular element is preferably less than 9 millimetres, more preferably less than 8.5 millimetres, more preferably less than 8 millimetres, more preferably less than 7.5 millimetres. For example, the internal diameter may be between 5 millimetres and 9 millimetres, or between 5.5 millimetres and 8.5 millimetres, or between 6 millimetres and 6 millimetres, or between 6.5 millimetres and 7.5 millimetres. The internal diameter may be around 7 millimetres.

The hollow tubular element preferably has a wall thickness of at least 100 micrometres, more preferably at least 150 micrometres, more preferably at least 200 micrometres, more preferably at least 250 micrometres, more preferably at least 500 micrometres. The wall thickness of the hollow tubular element may be less than 2 millimetres, preferably less than 1.5 millimetres and even more preferably less than 1.25 mm. The wall thickness of the hollow tubular element may be less than 1 millimetre. For example, the wall thickness of the hollow tubular element may be between 100 micrometres and 2 millimetres, or between 150 micrometres and 1.5 millimetres, or between 200 micrometres and 1.25 millimetres, or between 250 micrometres and 1 millimetre, or between 500 micrometres and 1 millimetre.

The hollow tubular element may comprise a paper-based material. The hollow tubular element may comprise at least one layer of paper. The paper may be very rigid paper. The paper may be crimped paper, such as crimped heat resistant paper or crimped parchment paper. Advantageously, a crimped paper may form one or more airflow channels extending around the outside of the capsule. The one or more airflow channels may be particularly advantageous in embodiments in which the capsule comprises at least one of an air inlet and an air outlet on a cylindrical wall of the capsule.

Preferably, the hollow tubular element is formed from cardboard. The hollow tubular element may be a cardboard tube. Advantageously, cardboard is a cost-effective material that provides a balance between being deformable in order to provide ease of insertion of the article into an aerosol-generating device and being sufficiently stiff to provide suitable engagement of the article with the interior of the device. A cardboard tube may therefore provide suitable resistance to deformation or compression during use.

The hollow tubular element may be a paper tube. The hollow tubular element may be a tube formed from spirally wound paper. The hollow tubular element may be formed from a plurality of layers of the paper. The paper may have a basis weight of at least about 50 grams per square meter, at least about 60 grams per square meter, at least about 70 grams per square meter, or at least about 90 grams per square meter.

The hollow tubular element may comprise a polymeric material. For example, the hollow tubular element may comprise a polymeric film. The polymeric film may comprise a cellulosic film. The hollow tubular element may comprise low density polyethylene (LDPE) or polyhydroxyalkanoate (PHA) fibres. The hollow tubular element may comprise cellulose acetate tow.

Where the hollow tubular element comprises cellulose acetate tow, the cellulose acetate tow may have a denier per filament of between about 2 and about 4 and a total denier of between about 25 and about 40.

In aerosol-generating articles according to the present invention, the hollow tubular element preferably provides a negligible level of resistance to draw (RTD). The term “negligible level of RTD” is used to describe an RTD of less than 1 mm H₂O per 10 millimetres of length of the hollow tubular element or hollow tubular element, preferably less than 0.4 mm H₂O per 10 millimetres of length of the hollow tubular element or hollow tubular element, more preferably less than 0.1 mm H₂O per 10 millimetres of length of the hollow tubular element or hollow tubular element.

The RTD of a hollow tubular element is preferably less than or equal to about 10 millimetres H₂O. More preferably, the RTD of a hollow tubular element is less than or equal to about 5 millimetres H₂O. Even more preferably, the RTD of a hollow tubular element is less than or equal to about 2.5 millimetres H₂O. Even more preferably, the RTD of the hollow tubular element is less than or equal to about 2 millimetres H₂O. Even more preferably, the RTD of the hollow tubular element is less than or equal to about 1 millimetre H₂O.

The RTD of a hollow tubular element may be at least 0 millimetres H₂O, or at least about 0.25 millimetres H₂O or at least about 0.5 millimetres H₂O or at least about 1 millimetre H₂O.

In some embodiments, the RTD of a hollow tubular element is from about 0 millimetre H₂O to about 10 millimetres H₂O, preferably from about 0.25 millimetres H₂O to about 10 millimetres H₂O, preferably from about 0.5 millimetres H₂O to about 10 millimetres H₂O. In other embodiments, the RTD of a hollow tubular element is from about 0 millimetres H₂O to about 5 millimetres H₂O, preferably from about 0.25 millimetres H₂O to about 5 millimetres H₂O preferably from about 0.5 millimetres H₂O to about 5 millimetres H₂O. In other embodiments, the RTD of a hollow tubular element is from about 1 millimetre H₂O to about 5 millimetres H₂O. In further embodiments, the RTD of a hollow tubular element is from about 0 millimetres H₂O to about 2.5 millimetres H₂O, preferably from about 0.25 millimetres H₂O to about 2.5 millimetres H₂O, more preferably from about 0.5 millimetres H₂O to about 2.5 millimetres H₂O. In further embodiments, the RTD of a hollow tubular element is from about 0 millimetres H₂O to about 2 millimetres H₂O, preferably from about 0.25 millimetres H₂O to about 2 millimetres H₂O, more preferably from about 0.5 millimetres H₂O to about 2 millimetres H₂O. In a particularly preferred embodiment, the RTD of a hollow tubular element is about 0 millimetre H₂O.

Aerosol-generating articles according to the invention may further comprise a downstream filter segment mounted within the hollow tubular element at a downstream end of the hollow tubular element. The downstream filter segment may extend to the downstream end of the hollow tubular element. The downstream end of the downstream filter segment may define the downstream end of the aerosol-generating article. The inclusion of a downstream filter segment within the hollow tubular element may be useful in order to provide a desired level of RTD for the aerosol-generating article.

The downstream filter segment is located downstream of the capsule and preferably, the capsule and the downstream filter segment are spaced apart in a longitudinal direction such that a cavity is defined between them. Preferably, the downstream filter segment is located at least 5 millimetres downstream from the downstream end of the capsule, more preferably at least 8 millimetres downstream from the downstream end of the capsule, more preferably at least 10 millimetres downstream from the downstream end of the capsule, more preferably at least 15 millimetres downstream from the downstream end of the capsule. Preferably, the downstream filter segment is located less than 30 millimetres downstream from the downstream end of the capsule, more preferably less than 25 millimetres downstream from the downstream end of the capsule. The distance defined between the downstream end of the capsule and the downstream filter segment corresponds to the length of the cavity between the capsule and the downstream filter segment.

The downstream filter segment is preferably a solid plug, which may also be described as a ‘plain’ plug and is non-tubular. The filter segment therefore preferably has a substantially uniform transverse cross section.

The downstream filter segment is preferably formed of a fibrous filtration material. The fibrous filtration material may be for filtering the aerosol that is generated from the aerosol-generating substrate. Suitable fibrous filtration materials would be known to the skilled person. Particularly preferably, the at least one downstream filter segment comprises a cellulose acetate filter segment formed of cellulose acetate tow.

The downstream filter segment may optionally comprise a flavourant, which may be provided in any suitable form. For example, the downstream filter segment may comprise one or more capsules, beads or granules of a flavourant, or one or more flavour loaded threads or filaments.

Preferably, the downstream filter segment has a low particulate filtration efficiency.

The downstream filter segment preferably has an external diameter that is approximately equal to the internal diameter of the hollow tubular element, so that the downstream filter segment is retained within the hollow tubular element by means of a friction fit.

Preferably, the external diameter of the downstream filter segment is between 5 millimetres and 12 millimetres, more preferably between 6 millimetres and 10 millimetres, more preferably between 7 millimetres and 8 millimetres.

Unless otherwise specified, the resistance to draw (RTD) of a component or the aerosol-generating article is measured in accordance with ISO 6565-2015. The RTD refers the pressure required to force air through the full length of a component. The terms “pressure drop” or “draw resistance” of a component or article may also refer to the “resistance to draw”. Such terms generally refer to the measurements in accordance with ISO 6565-2015 are normally carried out at under test at a volumetric flow rate of 17.5 millilitres per second at the output or downstream end of the measured component at a temperature of 22 degrees Celsius, a pressure of 101 kPa (about 760 Torr) and a relative humidity of 60%. Conditions for smoking and smoking machine specifications are set out in ISO Standard 3308 (ISO 3308:2000). Atmosphere for conditioning and testing are set out in ISO Standard 3402 (ISO 3402:1999).

The resistance to draw (RTD) of the downstream filter segment may be at least 0 millimetres H₂O, or at least 3 millimetres H₂O, or at least 6 millimetres H₂O.

The RTD of the downstream filter segment may be no greater than 12 millimetres H₂O, or no greater than 11 millimetres H₂O, or no greater than 10 millimetres H₂O.

As mentioned above, the downstream filter segment may be formed of a fibrous filtration material. The downstream filter segment may be formed of a porous material. The downstream filter segment may be formed of a biodegradable material. The downstream filter segment may be formed of a cellulose material, such as cellulose acetate. For example, a downstream filter segment may be formed from a bundle of cellulose acetate fibres having a denier per filament between 10 and 15. For example, a downstream filter segment formed from relatively low density cellulose acetate tow, such as cellulose acetate tow comprising fibres of 12 denier per filament.

The downstream filter segment may be formed of a polylactic acid based material. The downstream filter segment may be formed of a bioplastic material, preferably a starch-based bioplastic material. The downstream filter segment may be made by injection moulding or by extrusion. Bioplastic-based materials are advantageous because they are able to provide downstream filter segment structures which are simple and cheap to manufacture with a particular and complex cross-sectional profile, which may comprise a plurality of relatively large air flow channels extending through the downstream filter segment material, that provides suitable RTD characteristics.

The length of the downstream filter segment may be at least 5 millimetres, or at least 8 millimetres, or at least 10 millimetres. The length of the downstream filter segment may be less than 20 millimetres, or less than 15 millimetres, or less than 12 millimetres. For example, the length of the downstream filter segment may be between 5 millimetres and 20 millimetres, or between 8 millimetres and 15 millimetres, or between 8 millimetres and 12 millimetres, or between 10 millimetres and 12 millimetres.

In alternative embodiments of the present invention, a downstream filter segment may be provided downstream of the hollow tubular element. The downstream filter segment may extend between the hollow tubular element and the downstream end of the aerosol-generating article. In such embodiments, the downstream filter segment may be connected to the hollow tubular element by means of a tipping wrapper.

The overall RTD of the aerosol-generating article may be at least 1 millimetre H₂O. For example, the overall RTD of the aerosol-generating article may be at least 2 millimetres H₂O, at least 3 millimetres H₂O, at least 4 millimetres H₂O, at least 5 millimetres H₂O, at least 6 millimetres H₂O, at least 7 millimetres H₂O, at least 8 millimetres H₂O, at least 9 millimetres H₂O, at least 10 millimetres H₂O, at least 15 millimetres H₂O, at least 20 millimetres H₂O, at least 30 millimetres H₂O, at least 40 millimetres H₂O, or at least 50 millimetres H₂O.

The overall RTD of the aerosol-generating article may be no more than 180 millimetres H₂O. For example, the overall RTD of the aerosol-generating article may be no more than 170 millimetres H₂O, no more than 160 millimetres H₂O, no more than 150 millimetres H₂O, or no more than 140 millimetres H₂O.

The overall RTD of the aerosol-generating article may be between 1 millimetre H₂O and 180 millimetres H₂O. For example, the overall RTD of the aerosol-generating article may be between 5 millimetres H₂O and 170 millimetres H₂O, between 10 millimetres H₂O and 160 millimetres H₂O, between 20 millimetres H₂O and 150 millimetres H₂O, or between 50 millimetres H₂O and 140 millimetres H₂O.

The aerosol-generating article in accordance with the invention may have an overall length of at least 40 millimetres, or at least 50 millimetres, or at least 60 millimetres.

An overall length of an aerosol-generating article in accordance with the invention may be less than or equal to 90 millimetres, or less than or equal to 85 millimetres, or less than or equal to 80 millimetres.

In some embodiments, an overall length of the aerosol-generating article is preferably from 40 millimetres to 70 millimetres, more preferably from 45 millimetres to 70 millimetres. In other embodiments, an overall length of the aerosol-generating article is preferably from 40 millimetres to 60 millimetres, more preferably from about 45 millimetres to about 60 millimetres. In further embodiments, an overall length of the aerosol-generating article is preferably from 40 millimetres to 50 millimetres, more preferably from 45 millimetres to 50 millimetres. In an exemplary embodiment, an overall length of the aerosol-generating article is about 45 millimetres.

The aerosol-generating article may have an external diameter of at least 5 millimetres, or at least 6 millimetres, or at least 7 millimetres.

The aerosol-generating article may have an external diameter of less than or equal to about 12 millimetres, or less than or equal to about 10 millimetres, or less than or equal to about 8 millimetres.

In some embodiments, the aerosol-generating article has an external diameter from about 5 millimetres to about 12 millimetres, preferably from about 6 millimetres to about 12 millimetres, more preferably from about 7 millimetres to about 12 millimetres. In other embodiments, the aerosol-generating article has an external diameter from about 5 millimetres to about 10 millimetres, preferably from about 6 millimetres to about 10 millimetres, more preferably from about 7 millimetres to about 10 millimetres. In further embodiments, the aerosol-generating article has an external diameter from about 5 millimetres to about 8 millimetres, preferably from about 6 millimetres to about 8 millimetres, more preferably from about 7 millimetres to about 8 millimetres. In other embodiments, the aerosol-generating article has an external diameter of less than 7 millimetres.

The external diameter of the aerosol-generating article may be substantially constant over the whole length of the article. As an alternative, different portions of the aerosol-generating article may have different external diameters.

The present invention also relates to an aerosol-generating system comprising: an aerosol-generating article according to the invention as defined above; and an aerosol-generating device comprising a heating chamber for receiving the aerosol-generating article and a heating element provided in the heating chamber or about the periphery of the heating chamber.

The aerosol-generating device has a distal end and a mouth end. The aerosol-generating device may comprise a body. The body or housing of the aerosol-generating device may define a device cavity for removably receiving the aerosol-generating article at the mouth end of the device. The aerosol-generating device may comprise a heating element or heater for heating the aerosol-generating substrate when the aerosol-generating article is received within the device cavity.

The device cavity may be referred to as the heating chamber of the aerosol-generating device. The device cavity may extend between a distal end and a mouth, or proximal, end. The distal end of the device cavity may be a closed end and the mouth, or proximal, end of the device cavity may be an open end. An aerosol-generating article may be inserted into the device cavity, or heating chamber, via the open end of the device cavity. The device cavity may be cylindrical in shape so as to conform to the same shape of an aerosol-generating article.

The expression “received within” may refer to the fact that a component or element is fully or partially received within another component or element. For example, the expression “aerosol-generating article is received within the device cavity” refers to the aerosol-generating article being fully or partially received within the device cavity of the aerosol-generating article.

When the aerosol-generating article is received within the device cavity, the aerosol-generating article may abut the distal end of the device cavity. When the aerosol-generating article is received within the device cavity, the aerosol-generating article may be in substantial proximity to the distal end of the device cavity. The distal end of the device cavity may be defined by an end-wall.

The length of the device cavity may be between 15 millimetres and 80 millimetres, or between 20 millimetres and 70 millimetres, or between 25 millimetres and 60 millimetres, or between 25 millimetres and 50 millimetres.

The length of the device cavity may be between 25 millimetres and 29 millimetres, or between 26 millimetres and 29 millimetres, or between 27 millimetres or 28 millimetres.

When the aerosol-generating article is received within the device cavity, the capsule is preferably fully within the device cavity, in order to optimise the heating of the solid aerosol-generating substrate within the capsule. The length of the device cavity is therefore preferably greater than the length of the capsule.

A diameter of the device cavity may be between 4 millimetres and 10 millimetres. A diameter of the device cavity may be between 5 millimetres and 9 millimetres. A diameter of the device cavity may be between 6 millimetres and 8 millimetres. A diameter of the device cavity may be between 6 millimetres and 7 millimetres.

A diameter of the device cavity may be substantially the same as or greater than a diameter of the aerosol-generating article. A diameter of the device cavity may be the same as a diameter of the aerosol-generating article in order to establish a tight fit with the aerosol-generating article.

The device cavity may be configured to establish a tight fit with an aerosol-generating article received within the device cavity. Tight fit may refer to a snug fit. The aerosol-generating device may comprise a peripheral wall. Such a peripheral wall may define the device cavity, or heating chamber. The peripheral wall defining the device cavity may be configured to engage with an aerosol-generating article received within the device cavity in a tight fit manner, so that there is substantially no gap or empty space between the peripheral wall defining the device cavity and the aerosol-generating article when received within the device.

Such a tight fit may establish an airtight fit or configuration between the device cavity and an aerosol-generating article received therein.

With such an airtight configuration, there would be substantially no gap or empty space between the peripheral wall defining the device cavity and the aerosol-generating article for air to flow through.

The tight fit with an aerosol-generating article may be established along the entire length of the device cavity or along a portion of the length of the device cavity.

The aerosol-generating device may comprise an air-flow channel extending between a channel inlet and a channel outlet. The air-flow channel may be configured to establish a fluid communication between the interior of the device cavity and the exterior of the aerosol-generating device. The air-flow channel of the aerosol-generating device may be defined within the housing of the aerosol-generating device to enable fluid communication between the interior of the device cavity and the exterior of the aerosol-generating device. When an aerosol-generating article is received within the device cavity, the air-flow channel may be configured to provide air flow into the article in order to deliver generated aerosol to a user drawing from the mouth end of the article.

The air-flow channel of the aerosol-generating device may be defined within, or by, the peripheral wall of the housing of the aerosol-generating device. In other words, the air-flow channel of the aerosol-generating device may be defined within the thickness of the peripheral wall or by the inner surface of the peripheral wall, or a combination of both. The air-flow channel may partially be defined by the inner surface of the peripheral wall and may be partially defined within the thickness of the peripheral wall. The inner surface of the peripheral wall defines a peripheral boundary of the device cavity.

The air-flow channel of the aerosol-generating device may extend from an inlet located at the mouth end, or proximal end, of the aerosol-generating device to an outlet located away from mouth end of the device. The air-flow channel may extend along a direction parallel to the longitudinal axis of the aerosol-generating device.

The heater may be any suitable type of heater. Preferably, in the present invention, the heater is an external heater which heats the capsule and its contents externally. Such an external heater may circumscribe the aerosol-generating article when inserted in or received within the aerosol-generating device.

Alternatively, the heater may be an elongate heater blade that is adapted to be inserted into the capsule in order to internally heat the capsule and its contents.

The heater may comprise at least one heating element. The at least one heating element may be any suitable type of heating element. In some embodiments, the device comprises only one heating element. In some embodiments, the device comprises a plurality of heating elements.

The heating element may be a resistive heating element.

Suitable materials for forming the resistive heating element include but are not limited to: semiconductors such as doped ceramics, electrically ‘conductive’ ceramics (such as, for example, molybdenum disilicide), carbon, graphite, metals, metal alloys and composite materials made of a ceramic material and a metallic material. Such composite materials may comprise doped or undoped ceramics. Examples of suitable doped ceramics include doped silicon carbides. Examples of suitable metals include titanium, zirconium, tantalum and metals from the platinum group. Examples of suitable metal alloys include stainless steel, nickel-, cobalt-, chromium-, aluminium-titanium-zirconium-, hafnium-, niobium-, molybdenum-, tantalum-, tungsten-, tin-, gallium-, manganese- and iron-containing alloys, and super-alloys based on nickel, iron, cobalt, stainless steel, Timetal® and iron-manganese-aluminium based alloys.

In some embodiments, the resistive heating element comprises one or more stamped portions of electrically resistive material, such as stainless steel. Alternatively, the at least one resistive heating element may comprise a heating wire or filament, for example a Ni—Cr (Nickel-Chromium), platinum, tungsten or alloy wire.

In some embodiments, the heating element comprises an electrically insulating substrate, wherein the at least one resistive heating element is provided on the electrically insulating substrate.

The electrically insulating substrate may comprise any suitable material. For example, the electrically insulating substrate may comprise one or more of: paper, glass, ceramic, anodized metal, coated metal, and Polyimide. The ceramic may comprise mica, Alumina (Al₂O₃) or Zirconia (ZrO₂). Preferably, the electrically insulating substrate has a thermal conductivity of less than or equal to about 40 Watts per metre Kelvin, preferably less than or equal to about 20 Watts per metre Kelvin and ideally less than or equal to about 2 Watts per metre Kelvin.

The heater may comprise a heating element comprising a rigid electrically insulating substrate with one or more electrically conductive tracks or wire disposed on its surface. The size and shape of the electrically insulating substrate may allow it to be inserted directly into an aerosol-generating substrate. If the electrically insulating substrate is not sufficiently rigid, the heating element may comprise a further reinforcement means. A current may be passed through the one or more electrically conductive tracks to heat the heating element and the aerosol-generating substrate.

In some embodiments, the heater comprises an inductive heating arrangement. The inductive heating arrangement may comprise an inductor coil and a power supply configured to provide high frequency oscillating current to the inductor coil. As used herein, a high frequency oscillating current means an oscillating current having a frequency of between about 500 kHz and about 30 MHz. The heater may advantageously comprise a DC/AC inverter for converting a DC current supplied by a DC power supply to the alternating current. The inductor coil may be arranged to generate a high frequency oscillating electromagnetic field on receiving a high frequency oscillating current from the power supply. The inductor coil may be arranged to generate a high frequency oscillating electromagnetic field in the device cavity. In some embodiments, the inductor coil may substantially circumscribe the device cavity. The inductor coil may extend at least partially along the length of the device cavity.

The heater may comprise an inductive heating element. The inductive heating element may be a susceptor element. A susceptor element may be arranged such that, when the aerosol-generating article is received in the cavity of the aerosol-generating device, the oscillating electromagnetic field generated by the inductor coil induces a current in the susceptor element, causing the susceptor element to heat up. In these embodiments, the aerosol-generating device is preferably capable of generating a fluctuating electromagnetic field having a magnetic field strength (H-field strength) of between 1 and 5 kilo amperes per metre (kA m), preferably between 2 and 3 kA/m, for example about 2.5 kA/m. The electrically-operated aerosol-generating device is preferably capable of generating a fluctuating electromagnetic field having a frequency of between 1 and 30 MHZ, for example between 1 and 10 MHz, for example between 5 and 7 MHz.

In these embodiments, the susceptor element is preferably located in contact with the solid aerosol-generating substrate. In some embodiments, a susceptor element is located in the aerosol-generating device. In these embodiments, the susceptor element may be located in the cavity. The aerosol-generating device may comprise only one susceptor element. The aerosol-generating device may comprise a plurality of susceptor elements. In some embodiments, the susceptor element is preferably arranged to heat the outer surface of the aerosol-generating substrate.

The susceptor element may comprise any suitable.

In some embodiments the aerosol-generating device may comprise at least one resistive heating element and at least one inductive heating element. In some embodiments the aerosol-generating device may comprise a combination of resistive heating elements and inductive heating elements.

During use, the heater may be controlled to operate within a defined operating temperature range, below a maximum operating temperature. An operating temperature range between about 150 degrees Celsius and about 300 degrees Celsius in the heating chamber (or device cavity) is preferable. The operating temperature range of the heater may be between about 150 degrees Celsius and about 250 degrees Celsius.

The aerosol-generating device may comprise a power supply. The power supply may be a DC power supply. In some embodiments, the power supply is a battery. The power supply may be a nickel-metal hydride battery, a nickel cadmium battery, or a lithium based battery, for example a lithium-cobalt, a lithium-iron-phosphate or a lithium-polymer battery. However, in some embodiments the power supply may be another form of charge storage device, such as a capacitor. The power supply may require recharging and may have a capacity that allows for the storage of enough energy for one or more user operations, for example one or more aerosol-generating experiences.

The aerosol-generating device may comprise a piercing device for piercing the capsule when the aerosol-generating article is inserted into the device cavity. As described above, the piercing of the capsule may be necessary in order to establish one or more airflow pathways through the capsule.

Below, there is provided a non-exhaustive list of non-limiting examples. Any one or more of the features of these examples may be combined with any one or more features of another example, embodiment, or aspect described herein.

EX1. An aerosol-generating article for generating an inhalable aerosol upon heating, the aerosol-generating article comprising: a hollow tubular element; and a capsule mounted within the hollow tubular element at an upstream end of the hollow tubular element, the capsule comprising: a capsule outer wall defining an internal cavity; and a solid aerosol-generating substrate within the internal cavity of the capsule, the solid aerosol-generating substrate comprising nicotine and an aerosol former, wherein the aerosol former content of the aerosol-generating substrate is at least 15 percent by weight, on a dry weight basis.

EX2. An aerosol-generating article according to example EX1, wherein the internal cavity has a volume of at least 250 cubic millimetres.

EX3. An aerosol-generating article according to example EX1 or EX2, wherein the bulk density of the solid aerosol-generating substrate within the capsule is at least 0.1 milligrams per cubic millimetre of the internal cavity.

EX4. An aerosol-generating article according to any preceding example, wherein the aerosol-generating substrate comprises at least 40 percent by weight of aerosol former, on a dry weight basis.

EX5. An aerosol-generating article according to any preceding example, wherein the aerosol-generating substrate comprises no more than 80 percent by weight of aerosol former, on a dry weight basis.

EX6. An aerosol-generating article according to any preceding example, wherein the aerosol former comprises glycerol.

EX7. An aerosol-generating article according to any preceding example, wherein the aerosol-generating substrate comprises at least 0.5 percent by weight of nicotine on a dry weight basis.

EX8. An aerosol-generating article according to any preceding example, wherein the aerosol-generating substrate further comprises one or more carboxylic acids.

EX9. An aerosol-generating article according to any preceding example, wherein the aerosol-generating substrate is in the form of an aerosol-generating film comprising a cellulosic based film-forming agent, nicotine and aerosol former.

EX10. An aerosol-generating article according to example EX9 wherein the aerosol-generating film further comprises a cellulosic based strengthening agent.

EX11. An aerosol-generating article according to examples EX9 or EX10, wherein the aerosol-generating film is substantially tobacco free.

EX12. An aerosol-generating article according to any of examples EX1 to EX8, wherein the aerosol-generating substrate comprises a gel composition that comprises nicotine, at least one gelling agent and aerosol former.

EX13. An aerosol-generating article according to example EX12, wherein the gel composition is substantially tobacco free.

EX14. An aerosol-generating article according to examples EX12 or EX13, wherein the gel composition comprises at least 50 percent by weight of aerosol former.

EX15. An aerosol-generating article according to any preceding example, wherein the capsule contains a plurality of particles of the solid aerosol-generating substrate.

EX16. An aerosol-generating article according to example EX15, wherein the maximum dimension of each of the particles is at least 0.25 millimetres.

EX17. An aerosol-generating article according to example EX15 or EX16, wherein the maximum dimension of each of the particles is no more than 10 millimetres.

EX18. An aerosol-generating article according to any of examples EX15 to EX17, wherein the capsule comprises at least 10 particles of the aerosol-generating substrate.

EX19. An aerosol-generating article according to any of examples EX15 to EX17, wherein the solid aerosol-generating substrate is in the form of a powder.

EX20. An aerosol-generating article according to example EX19, wherein the powder is formed of particles having a D50 size of between 50 micrometres and 80 micrometres.

EX21. An aerosol-generating article according to example EX19 or EX20, wherein the powder is formed of particles having a maximum diameter of between 50 micrometres and 250 micrometres.

EX22. An aerosol-generating article according to any of examples EX15 to EX21, wherein the mass of each particle is at least 0.05 micrograms.

EX23. An aerosol-generating article according to any of examples EX1 to EX14, wherein the solid aerosol-generating substrate may be in the form of one or more sheets.

EX24. An aerosol-generating article according to any of the preceding examples, wherein the capsule outer wall is formed of an air impermeable material.

EX25. An aerosol-generating article according to any of the preceding examples, wherein the capsule outer wall comprises a polymeric material.

EX26. An aerosol-generating article according to any of the preceding examples, wherein the capsule outer wall is formed of a pierceable material.

EX27. An aerosol-generating article according to any of the preceding examples, wherein the capsule is in the form of a sphero-cylinder.

EX28. An aerosol-generating article according to any of the preceding examples, wherein the capsule is a two part capsule.

EX29. An aerosol-generating article according to example EX28, wherein the capsule comprises a first part and a second part, wherein the second part has a smaller outer diameter than the first part such that an end of the second part can be inserted into an open end of the first part in order to close the capsule.

EX30. An aerosol-generating article according to example EX28 or EX29, wherein the outer diameter of the first part of the capsule is larger than the internal diameter of the hollow tubular element and wherein only the second part of the capsule is mounted in the hollow tubular element.

EX31. An aerosol-generating article according to example EX29, wherein the capsule is fully inserted into the hollow tubular element and wherein the outer diameter of the second part is smaller than the internal diameter of the hollow tubular element to provide a space between the outer surface of the second part and the inner surface of the hollow tubular element.

EX32. An aerosol-generating article according to any of the preceding examples, wherein the capsule has a length of at least 10 millimetres.

EX33. An aerosol-generating article according to any of the preceding examples, wherein the capsule has a maximum diameter of at least 5 millimetres.

EX34. An aerosol-generating article according to any of the preceding examples, wherein the internal cavity of the capsule contains at least 50 milligrams of the solid aerosol-generating substrate.

EX35. An aerosol-generating article according to any of the preceding examples, wherein the internal cavity of the capsule has a volume of less than 2000 cubic millimetres.

EX36. An aerosol-generating article according to any of the preceding examples, wherein the bulk density of the solid aerosol-generating substrate within the capsule is less than 2 milligrams per cubic millimetre of the internal cavity.

EX37. An aerosol-generating article according to any of the preceding examples, wherein the percentage fill of the capsule is at least 50 percent.

EX38. An aerosol-generating article according to any of the preceding examples, wherein the percentage fill of the capsule is less than 90 percent.

EX39. An aerosol-generating article according to any of the preceding examples, wherein the capsule is adapted such that one or more airflow pathways are provided through the capsule during heating.

EX40. An aerosol-generating article according to example EX39, wherein the capsule is adapted such that airflow pathways are created when the aerosol-generating article is inserted into an aerosol-generating device.

EX41. An aerosol-generating article according to example EX39, wherein the capsule comprises at least one air inlet and at least one air outlet in the capsule outer wall.

EX42. An aerosol-generating article according to example EX41, wherein each of the at least one air inlet and at least one air outlet is in the form of a hole through the capsule outer wall.

EX43. An aerosol-generating article according to example EX42, wherein each hole forming an air inlet or air outlet has a diameter of at least 0.2 millimetres.

EX44. An aerosol-generating article according to example EX42 or EX43, wherein each hole forming an air inlet or air outlet has a diameter of less than 2 millimetres.

EX45. An aerosol-generating article according to any of examples EX42 to EX44, wherein the holes are spaced at least 1 millimetre apart from each other.

EX46. An aerosol-generating article according to any of examples EX41 to EX45, wherein the at least one air outlet is preferably at least 5 millimetres downstream of the at least one air inlet.

EX47. An aerosol-generating article according to any of examples EX41 to EX46, wherein the at least one air outlet is positioned at the downstream end of the capsule.

EX48. An aerosol-generating article according to any of examples EX41 to EX47, wherein the at least one air inlet is positioned at the upstream end of the capsule.

EX49. An aerosol-generating article according to any of examples EX41 to EX47, wherein the at least one air inlet is positioned at least 2 millimetres downstream of the upstream end of the capsule.

EX50. An aerosol-generating article according to any of examples EX41 to EX49, wherein the capsule comprises a cylindrical wall and rounded end walls at the upstream and downstream ends of the cylindrical wall and the at least one air inlet is provided in the cylindrical wall, downstream of the upstream end wall.

EX51. An aerosol-generating article according to any of examples EX41 to EX50, wherein the capsule is mounted within the hollow tubular element such that the at least one air inlet is uncovered.

EX52. An aerosol-generating article according to any of examples EX41 to EX51, wherein the capsule is mounted within the hollow tubular element such that a portion of the capsule extends from the upstream end of the hollow tubular element whereby the at least one air inlet is positioned outside of the hollow tubular element.

EX53. An aerosol-generating article according to example EX52, wherein at least 20 percent of the length of the capsule protrudes from the hollow tubular element.

EX54. An aerosol-generating article according to example EX52 or EX53, wherein the hollow tubular element comprises an annular flange extending from the internal surface, to prevent movement of the capsule downstream.

EX55. An aerosol-generating article according to any of examples EX1 to EX51, wherein the capsule is provided with an outer diameter that is less than the internal diameter of the hollow tubular element, in order to provide a space between the outer surface of the capsule and the inner surface of the hollow tubular element.

EX56. An aerosol-generating article according to example EX55, wherein the outer diameter of the capsule is at least 0.2 millimetres less than the internal diameter of the hollow tubular element.

EX57. An aerosol-generating article according to example EX55 or EX56, further comprising an annular sealing ring around the capsule, within the hollow tubular element, to seal the space between the capsule and the inner surface of the hollow tubular element at a position downstream of the at least one air inlet.

EX58. An aerosol-generating article according to any of examples EX1 to EX51, wherein the inner surface of the hollow tubular element is corrugated at the upstream end thereof, to define a plurality of longitudinal channels which are circumferentially arranged to substantially coincide with the at least one air inlet.

EX59. An aerosol-generating article according to any of the preceding examples, wherein the hollow tubular element defines an empty cavity downstream of the capsule.

EX60. An aerosol-generating article according to example EX59, wherein the empty cavity has a length of at least 10 millimetres.

EX61. An aerosol-generating article according to any of the preceding examples, wherein the hollow tubular element has a total length of at least 25 millimetres.

EX62. An aerosol-generating article according to any of the preceding examples, wherein the hollow tubular element has an internal diameter of at least 5 millimetres.

EX63. An aerosol-generating article according to any of the preceding examples, wherein the hollow tubular element has a wall thickness of at least 100 micrometres.

EX64. An aerosol-generating article according to any of the preceding examples, wherein the hollow tubular element comprises a paper based material.

EX65. An aerosol-generating article according to example EX64, wherein the hollow tubular element is formed of crimped paper.

EX66. An aerosol-generating article according to any of the preceding examples, wherein the hollow tubular element has an RTD of less than 10 millimetres H₂O.

EX67. An aerosol-generating article according to any of the preceding examples, further comprising a downstream filter segment mounted within the hollow tubular element at a downstream end of the hollow tubular element.

EX68. An aerosol-generating article according to example EX67, wherein the downstream filter segment is located at least 5 millimetres downstream from the downstream end of the capsule.

EX69. An aerosol-generating article according to example EX67 or EX68, wherein the downstream filter segment has an RTD of less than 12 millimetres H₂O.

EX70. An aerosol-generating system comprising: an aerosol-generating article according to any of the preceding examples; and an aerosol-generating device comprising a heating chamber for receiving the aerosol-generating article and a heating element provided in the heating chamber or about the periphery of the heating chamber.

In the following, the invention will be further described with reference to the drawings of the accompanying Figures, wherein:

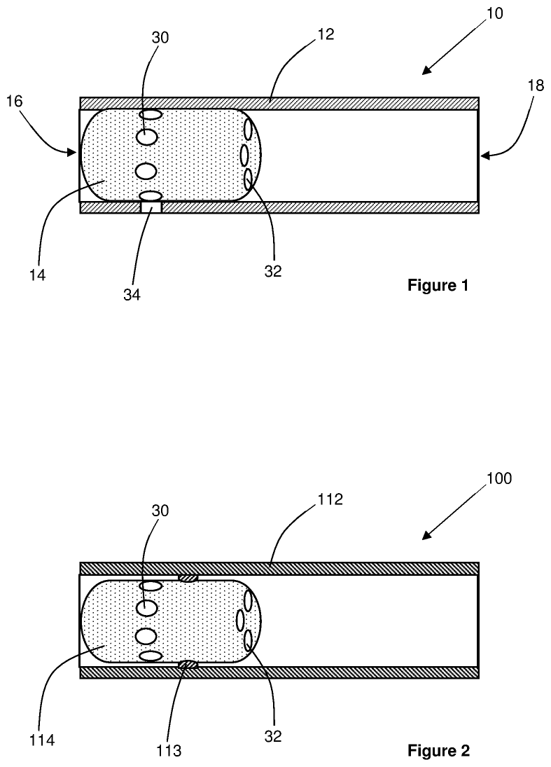

FIG. 1 shows a schematic side sectional view of an aerosol-generating article in accordance with a first embodiment of the invention;

FIG. 2 shows a schematic side sectional view of an aerosol-generating article in accordance with a second embodiment of the invention;

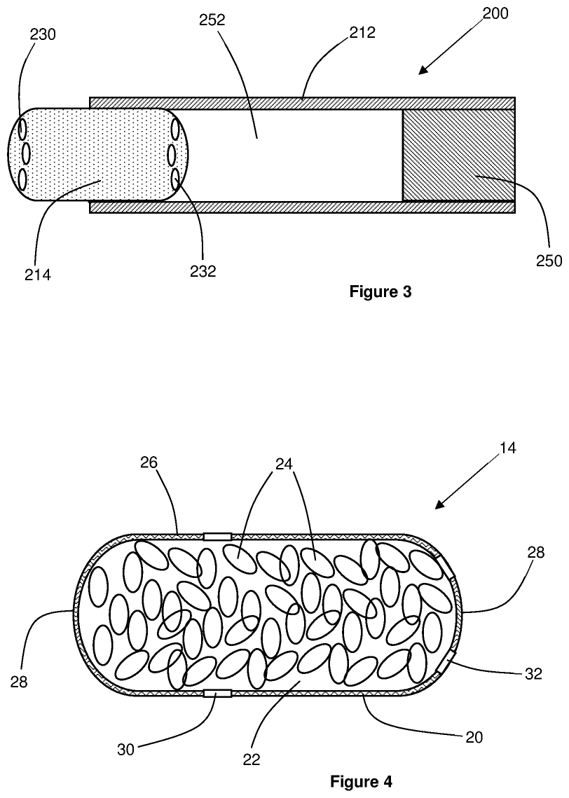

FIG. 3 shows a schematic side sectional view of an aerosol-generating article in accordance with a third embodiment of the invention; and

FIG. 4 shows a schematic side sectional view of a capsule suitable for use in the aerosol-generating articles of the first, second and third embodiments.

The aerosol-generating article 10 shown in FIG. 1 comprises a hollow tubular element 12 and a capsule 14 mounted at the upstream end of the hollow tubular element 12. The aerosol-generating article 10 extends from an upstream or distal end 16—which substantially coincides with an upstream end of the hollow tubular element 12—to a downstream or mouth end 18, which coincides with a downstream end of the hollow tubular element 12.

The aerosol-generating article 10 has an overall length of about 45 millimetres and an external diameter of about 7.2 mm.

The hollow tubular element 12 is formed of a cylindrical cardboard tube having a wall thickness of approximately 0.25 millimetres. The hollow tubular element 12 defines an internal channel that extends between the upstream and downstream ends of the aerosol-generating article. The hollow tubular element 12 has a length of about 45 millimetres, an external diameter of about 7.2 millimetres and an internal diameter of about 6.7 millimetres.

The capsule 14 is mounted within the internal channel of the hollow tubular element 12 at the upstream end, such that the upstream end of the capsule 14 substantially coincides with the upstream end of the hollow tubular element 12.

FIG. 4 shows a more detailed view of a suitable capsule 14 for use in the aerosol-generating article 10.

The capsule 14 is a two part capsule formed of an air impermeable polymer such as HPMC. The capsule 14 has an elongate, capsule (sphero-cylindrical) shape with a round cross section. The capsule comprises a capsule outer wall 20 defining an internal cavity 22 which contains a plurality of beads 24 of solid aerosol-generating substrate (not shown in FIG. 1). The capsule outer wall 20 is defined by a cylindrical wall 26 and opposed hemispherical end walls 28, which are integrally formed with the cylindrical wall 26. The capsule 14 has a length of about 20 millimetres and an external diameter of about 6.7 millimetres. The external diameter of the capsule 14 is therefore similar to the internal diameter of the hollow tubular element 12 such that the capsule is retained within the hollow tubular element 12 by means of a friction fit.

The capsule has an internal volume of about 600 cubic millimetres and contains about 200 milligrams of the solid aerosol-generating substrate. The capsule therefore contains approximately 0.33 milligrams of aerosol-generating substrate per cubic millimetre of the internal cavity 22.

The capsule 14 comprises a plurality of air inlets 30 each of which is in the form of a hole extending through the capsule outer wall 20 and having a diameter of about 0.5 millimetres. The plurality of air inlets 30 are spaced apart circumferentially around the capsule, on the cylindrical wall 26 of the capsule 14. Each of the air inlets 30 is provided about 8 millimetres downstream of the upstream end of the capsule.

The capsule 14 further comprises a plurality of air outlets 32 each of which is in the form of a hole extending through the capsule outer wall 20 and having a diameter of about 0.3 millimetres. The plurality of air outlets 32 are spaced apart in a circular formation on the downstream end wall 28 of the capsule 14.

The hollow tubular element 12 is provided with a plurality of ventilation holes 34 which extend through the peripheral wall of the hollow tubular element 12. Each of the ventilation holes 34 coincides with an air inlet 30 of the capsule 14.

The arrangement of air inlets 30, air outlets 32 and ventilation holes 34 defines a plurality of airflow pathways through the internal cavity 22 of the capsule 14 such that during heating, ambient air can be drawn into the hollow tubular element 12 through the ventilation holes 34 then through the capsule 14 and in contact with the beads 24 of solid aerosol-generating substrate. Aerosol generated from the beads 24 of solid aerosol-generating substrate upon heating will be drawn out of the capsule 14 along with the ambient air, through the air outlets 32 and along the hollow tubular element 12 to the downstream end of the aerosol-generating article.

Each of the beads 24 of solid aerosol-generating substrate contained within the capsule 14 is spherical in shape with a diameter of 0.8 millimetres. The beads are formed of a gel composition having the following composition:

| Component | % by weight |
|---|---|
| Glycerin | 76.8 |
| Alginate | 3.8 |
| Nicotine | 2.4 |
| Levulinic acid | 2.1 |
| Water | 14.4 |
| Calcium chloride | 0.5 |

The aerosol-generating article 100 shown in FIG. 2 has a similar structure to the aerosol-generating article 10 described above in relation to FIG. 1 but with the following differences.

The hollow tubular element 112 of the aerosol-generating article 100 has a similar structure to the hollow tubular element 12 of aerosol-generating article but there are no ventilation holes in the peripheral wall of the hollow tubular element 112. Furthermore, the hollow tubular element 112 comprises an annular flange 113 extending inwards from the internal surface of the hollow tubular element 112 at a distance of about 12 millimetres from the upstream end of the hollow tubular element 112. The annular flange 113 extends to the external surface of the capsule 114 and acts to retain the capsule 114 in place within the hollow tubular element 112.

The capsule 114 is similar in structure to the capsule 14 of the aerosol-generating article 10 shown in FIG. 1 and includes a similar arrangement of air inlets 30 and air outlets 32. However, the external diameter of the capsule 114 is approximately 0.8 millimetres smaller than the internal diameter of the hollow tubular element 112 such that a space is provided between the outer surface of the capsule 114 and the inner surface of the hollow tubular element 112. This space provides separation between the capsule 114 and the hollow tubular element 112 and enables the air inlets 30 on the cylindrical wall 26 to be uncovered so that air can enter the capsule 114 during use. The annular flange 113 retains the capsule 114 in place and also retains the separation between the capsule 114 and the inner surface of the hollow tubular element 112.

The capsule 114 contains a plurality of flakes of an aerosol-generating film (not shown) having the following composition:

| Component | % by weight |
|---|---|
| HPMC | 22.39 |
| Cellulose fibres | 16.79 |
| Sodium | 5.60 |
| carboxymethylcellulose | |
| Nicotine | 1.40 |
| Glycerol | 50.37 |
| Lactic acid | 3.45 |

The aerosol-generating article 200 shown in FIG. 3 comprises a hollow tubular element 212, a capsule 214 mounted at the upstream end of the hollow tubular element 112 and a downstream filter segment 250 mounted at the downstream end of the hollow tubular element.

The hollow tubular element 212 of the aerosol-generating article 200 has a similar structure to the hollow tubular element 12 of aerosol-generating article but there are no ventilation holes in the peripheral wall of the hollow tubular element 212.

The capsule 214 is mounted within the hollow tubular element 212 such that approximately 50 percent of the capsule 214 extends beyond the upstream end of the hollow tubular element 212. The capsule 214 therefore protrudes from the upstream end of the hollow tubular element 212 and the upstream end of the capsule 214 defines the upstream end of the aerosol-generating article 200.

The capsule 214 has a similar size and shape to the capsule 14 described above in relation to FIGS. 1 and 4 and is retained in the hollow tubular element 212 by means of a friction fit.

The capsule 214 comprises a plurality of air inlets 230 each of which is in the form of a hole extending through the capsule outer wall 20 and having a diameter of about 0.5 millimetres. The plurality of air outlets 32 are spaced apart in a circular formation on the upstream end wall of the capsule 214. The protrusion of the capsule 214 from the upstream end of the hollow tubular element 212 means that the air inlets 230 are located outside of the hollow tubular element 212.

The capsule 214 also comprises a plurality of air outlets 232 each of each of which is in the form of a hole extending through the capsule outer wall 20 and having a diameter of about 0.5 millimetres. The plurality of air outlets 32 are spaced apart in a circular formation on the downstream end wall of the capsule 214. The air inlets 230 and air outlets 232 are arranged to be substantially symmetric to each other, at opposite ends of the capsule 214.

The capsule 214 contains a plurality of gel beads (not shown) having the same composition as described above in relation to the embodiment shown in FIG. 1.

The downstream filter segment 250 is spaced apart from the capsule 214 to define an empty cavity 252 inside the hollow tubular element 212. The empty cavity 252 has a length of about 25 millimetres. The downstream filter segment 250 extends to the downstream end of the hollow tubular element 212 such that the downstream end of the downstream filter segment 250 substantially coincides with the downstream end of the aerosol-generating article 200.

The downstream filter segment 250 has a length of about 10 millimetres and comprises a low-density, cellulose acetate filter segment. The RTD of the downstream filter segment is about 10 mm H₂O.

For the purpose of the present description and of the appended claims, except where otherwise indicated, all numbers expressing amounts, quantities, percentages, and so forth, are to be understood as being modified in all instances by the term “about”. Also, all ranges include the maximum and minimum points disclosed and include any intermediate ranges therein, which may or may not be specifically enumerated herein. In this context, therefore, a number A is understood as A±10% of A. Within this context, a number A may be considered to include numerical values that are within general standard error for the measurement of the property that the number A modifies. The number A, in some instances as used in the appended claims, may deviate by the percentages enumerated above provided that the amount by which A deviates does not materially affect the basic and novel characteristic(s) of the claimed invention. Also, all ranges include the maximum and minimum points disclosed and include any intermediate ranges therein, which may or may not be specifically enumerated herein.

1.-17. (canceled)

18. An aerosol-generating article for generating an inhalable aerosol upon heating, the aerosol-generating article comprising:
a hollow tubular element; and
a capsule mounted within the hollow tubular element at an upstream end of the hollow tubular element, the capsule comprising:
a capsule outer wall defining an internal cavity having a volume of at least 250 cubic millimetres, and
a solid aerosol-generating substrate within the internal cavity of the capsule, the solid aerosol-generating substrate comprising nicotine and an aerosol former, wherein the aerosol former content of the aerosol-generating substrate is at least 15 percent by weight, on a dry weight basis, and wherein the density of the solid aerosol-generating substrate within the capsule is at least 0.1 milligrams per cubic millimetre of the internal cavity,
wherein the hollow tubular element defines an empty cavity downstream of the capsule.

19. The aerosol-generating article according to claim 18, wherein the empty cavity defined within the hollow tubular element has a length of at least 10 millimetres.

20. The aerosol-generating article according to claim 18, wherein the empty cavity defined within the hollow tubular element extends to the downstream end of the aerosol-generating article.

21. The aerosol-generating article according to claim 18, further comprising a downstream filter segment mounted within the hollow tubular element at a downstream end of the hollow tubular element.

22. The aerosol-generating article according to claim 18, wherein the capsule outer wall is formed of an air-impermeable polymeric material.

23. The aerosol-generating article according to claim 18, wherein the capsule further comprises at least one air inlet and at least one air outlet in the capsule outer wall, the at least one air inlet and at least one air outlet defining one or more airflow pathways through the internal cavity.

24. The aerosol-generating article according to claim 23, wherein the at least one air inlet in the capsule outer wall is provided at least 2 millimetres downstream from the upstream end of the capsule.

25. The aerosol-generating article according to claim 23, wherein the at least one air inlet is provided on a cylindrical wall of the capsule.

26. The aerosol-generating article according to claim 23, wherein the capsule protrudes from the upstream end of the hollow tubular element, such that the at least one air inlet is outside of the hollow tubular element.

27. The aerosol-generating article according to claim 18, wherein the solid aerosol-generating substrate fills at least 50 percent of the volume of the internal cavity.

28. The aerosol-generating article according to claim 18,
wherein the solid aerosol-generating substrate further comprises an aerosol-generating film, the aerosol-generating film comprising a cellulosic based film forming agent, nicotine, and glycerol, and
wherein the aerosol-generating film has a glycerol content of at least 40 percent by weight.

29. The aerosol-generating article according to claim 28, wherein the aerosol-generating film is substantially tobacco free.

30. The aerosol-generating article according to claim 18, wherein the capsule contains a plurality of particles of the solid aerosol-generating substrate.

31. The aerosol-generating article according to claim 18, wherein the capsule contains one or more sheets of the solid aerosol-generating substrate.

32. The aerosol-generating article according to claim 18, wherein an outer diameter of the capsule is at least 0.5 millimetre less than an internal diameter of the hollow tubular element.

33. The aerosol-generating article according to claim 18, wherein an inner wall of the hollow tubular element comprises a plurality of longitudinal corrugations.

34. An aerosol-generating system, comprising:
an aerosol-generating article according to claim 18; and
an aerosol-generating device comprising a heating chamber configured to receive the aerosol-generating article and a heating element provided in the heating chamber or about the periphery of the heating chamber.
